(19) United States
(12) Patent Application Publication
(10) Pub. No.: US 2016/0177152 A1
(43) Pub. Date: Jun. 23, 2016

(54) SHAPED ABRASIVE PARTICLE AND METHOD OF FORMING SAME

(71) Applicant: Saint-Gobain Ceramics & Plastics, Inc., Worcester, MA (US)

(72) Inventor: Paul BRAUN, Providence, RI (US)

(21) Appl. No.: 14/581,514

(22) Filed: Dec. 23, 2014

(51) Int. Cl. C09K 3/14

(52) U.S. Cl. CPC C09K 3/1409

(57) ABSTRACT

A method of forming a shaped abrasive particle including forming a mixture comprising a ceramic material into a sheet and sectioning at least a portion of the sheet using a mechanical object and forming at least one shaped abrasive particle from the sheet, and where sectioning includes controlling at least one process parameter consisting of an extrusion height, a sheet moisture content, a sheet solids loading, an orientation of the sheet during sectioning, a pressure differential during sectioning, a blade spacing variation, a blade edge thickness, a ratio of blade edge thickness to blade spacing variation, and a combination of one or more of the process parameters.

### BACKGROUND

1. Field of the Disclosure

The following is directed to shaped abrasive particles, and more particularly, to shaped abrasive particles having certain features and methods of forming such shaped abrasive particles.

2. Description of the Related Art

Abrasive articles incorporating abrasive particles are useful for various material removal operations including grinding, finishing, polishing, and the like. Depending upon the type of abrasive material, such abrasive particles can be useful in shaping or grinding various materials in the manufacturing of goods. Certain types of abrasive particles have been formulated to date that have particular geometries, such as triangular shaped abrasive particles and abrasive articles incorporating such objects. See, for example, U.S. Pat. Nos. 5,201,916; 5,366,523; and 5,984,988.

Previously, three basic technologies that have been employed to produce abrasive particles having a specified shape, which are fusion, sintering, and chemical ceramic. In the fusion process, abrasive particles can be shaped by a chill roll, the face of which may or may not be engraved, a mold into which molten material is poured, or a heat sink material immersed in an aluminum oxide melt. See, for example, U.S. Pat. No. 3,377,660. In sintering processes, abrasive particles can be formed from refractory powders having a particle size of up to 10 micrometers in diameter. Binders can be added to the powders along with a lubricant and a suitable solvent to form a mixture that can be shaped into platelets or rods of various lengths and diameters. See, for example, U.S. Pat. No. 3,079,242. Chemical ceramic technology involves converting a colloidal dispersion or hydrosol (sometimes called a sol) to a gel or any other physical state that restrains the mobility of the components, drying, and firing to obtain a ceramic material. See, for example, U.S. Pat. Nos. 4,744,802 and 4,848,041.

The industry continues to demand improved abrasive materials and abrasive articles.

### SUMMARY

According to a first aspect, a method of forming a shaped abrasive particle includes forming a mixture comprising a ceramic material into a sheet and sectioning at least a portion of the sheet using a mechanical object and forming at least one shaped abrasive particle from the sheet, wherein sectioning includes controlling at least one process parameter selected from the group consisting of an extrusion height, a sheet moisture content, a sheet solids loading, an orientation of the sheet during sectioning, a pressure differential during sectioning, a blade spacing variation, a blade edge thickness, a ratio of blade edge thickness to blade spacing variation, a blade edge shape, and a combination thereof.

### BRIEF DESCRIPTION OF THE DRAWINGS

The present disclosure may be better understood, and its numerous features and advantages made apparent to those skilled in the art by referencing the accompanying drawings.

FIGS. 1A and 1B include schematics of a system and method of forming a shaped abrasive particle in accordance with an embodiment.

FIG. 2 includes a particular device that can be used in forming a shaped abrasive particle in accordance with an embodiment.

FIG. 3 includes an illustration of a process of forming a shaped abrasive particle in accordance with an embodiment.

FIG. 4A includes a cross-sectional illustration of a process utilized in forming a shaped abrasive particle in accordance with an embodiment.

FIG. 4B includes a cross-sectional illustration of a portion of a sheet having an opening according to an embodiment.

FIG. 5 includes a cross-sectional illustration of a portion of a shaped abrasive particle in accordance with an embodiment.

FIG. 6 includes a cross-sectional illustration of a coated abrasive article including shaped abrasive particles in accordance with an embodiment.

FIG. 7 includes an illustration of a bonded abrasive article including shaped abrasive particles in accordance with an embodiment.

FIG. 8 includes a cross-sectional view of a portion of a die and extruding process according to an embodiment.

FIG. 9 includes an illustration of a plurality of blades according to an embodiment.

FIG. 10 includes an image of a portion of a sectioned sheet including a plurality of precursor shaped abrasive particles according to an embodiment.

FIG. 11 includes a top down images of the precursor shaped abrasive particles formed in the sheet according to Example 1.

FIG. 12 includes a top down image of shaped abrasive particles formed according to Example 1.

FIGS. 13A and 13B include cross-sectional illustrations of different blade edges according to embodiments.

### DETAILED DESCRIPTION

The following is directed to methods of forming shaped abrasive particles and features of such shaped abrasive particles. The shaped abrasive particles may be used in various abrasive articles, including for example bonded abrasive articles, coated abrasive articles, and the like. Alternatively, the shaped abrasive particles of the embodiments herein may be utilized in free abrasive technologies, including for example grinding and/or polishing slurries.

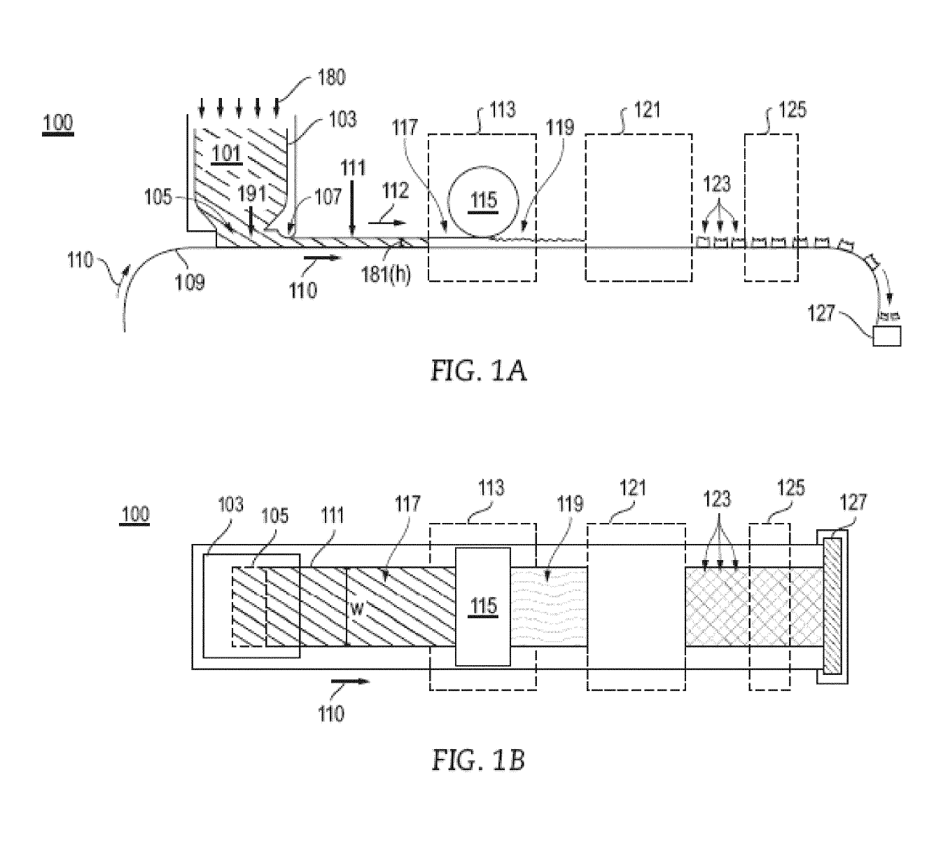

FIG. 1A includes a side view of a system for forming a shaped abrasive particle in accordance with an embodiment. FIG. 1B includes a top-down view of the system for forming a shaped abrasive particle in accordance with an embodiment. The process of forming shaped abrasive particles can be initiated by forming a mixture 101 including a ceramic material and a liquid. In particular, the mixture 101 can be a gel formed of a ceramic powder material and a liquid, wherein the gel can be characterized as a shape-stable material having the ability to hold a given shape even in the green (i.e., unfired) state. In accordance with an embodiment, the gel can include a powder material that is an integrated network of discrete particles.

The mixture 101 can be formed to have a particular content of solid material, which otherwise may be referred to as the solids content, such as the ceramic powder material. For example, in one embodiment, the mixture 101 can have a solids content of at least about 25 wt %, such as at least about 35 wt %, at least about 38 wt %, or even at least about 42 wt % for the total weight of the mixture 101. Still, in at least one non-limiting embodiment, the solid content of the mixture 101 can be not greater than about 75 wt %, such as not greater than about 70 wt %, not greater than about 65 wt %, or even not greater than about 55 wt %. It will be appreciated that the content of the solids materials in the mixture 101 can be within a range between any of the minimum and maximum percentages noted above.

According to one embodiment, the ceramic powder material can include an oxide, a nitride, a carbide, a boride, an oxycarbide, an oxynitride, and a combination thereof. In particular instances, the ceramic material can include alumina. More specifically, the ceramic material may include a boehmite material, which may be a precursor of alpha alumina. The term “boehmite” is generally used herein to denote alumina hydrates including mineral boehmite, typically being Al2O3.H2O and having a water content on the order of 15%, as well as psuedoboehmite, having a water content higher than 15%, such as 20-38% by weight. It is noted that boehmite (including psuedoboehmite) has a particular and identifiable crystal structure, and accordingly unique X-ray diffraction pattern, and as such, is distinguished from other aluminous materials including other hydrated aluminas such as ATH (aluminum trihydroxide) a common precursor material used herein for the fabrication of boehmite particulate materials.

Furthermore, the mixture 101 can be formed to have a particular content of liquid material. Some suitable liquids may include organic materials, such as water. In accordance with one embodiment, the mixture 101 can be formed to have a liquid content less than the solids content of the mixture 101. In more particular instances, the mixture 101 can have a liquid content of at least about 25 wt % for the total weight of the mixture 101. In other instances, the amount of liquid within the mixture 101 can be greater, such as at least about 35 wt %, at least about 45 wt %, at least about 50 wt %, or even at least about 58 wt %. Still, in at least one non-limiting embodiment, the liquid content of the mixture can be not greater than about 75 wt %, such as not greater than about 70 wt %, not greater than about 65 wt %, not greater than about 60 wt %, or even not greater than about 55 wt %. It will be appreciated that the content of the liquid in the mixture 101 can be within a range between any of the minimum and maximum percentages noted above.

Furthermore, to facilitate processing and forming shaped abrasive particles according to embodiments herein, the mixture 101 can have a particular storage modulus. For example, the mixture 101 can have a storage modulus of at least about 1×10⁴ Pa, such as at least about 4×10⁴ Pa, or even at least about 5×10⁴ Pa. However, in at least one non-limiting embodiment, the mixture 101 may have a storage modulus of not greater than about 1×10⁷ Pa, such as not greater than about 1×10⁶ Pa. It will be appreciated that the storage modulus of the mixture 101 can be within a range between any of the minimum and maximum values noted above. The storage modulus can be measured via a parallel plate system using ARES or AR-G2 rotational rheometers, with Peltier plate temperature control systems. For testing, the mixture 101 can be extruded within a gap between two plates that are set to be approximately 8 mm apart from each other. After extruding the get into the gap, the distance between the two plates defining the gap is reduced to 2 mm until the mixture 101 completely fills the gap between the plates. After wiping away excess mixture, the gap is decreased by 0.1 mm and the test is initiated. The test is an oscillation strain sweep test conducted with instrument settings of a strain range between 0.1% to 100%, at 6.28 rad/s (1 Hz), using 25-mm parallel plate and recording 10 points per decade. Within 1 hour after the test completes, lower the gap again by 0.1 mm and repeat the test. The test can be repeated at least 6 times. The first test may differ from the second and third tests. Only the results from the second and third tests for each specimen should be reported. The viscosity can be calculated by dividing the storage modulus value by 6.28 s-1.

Furthermore, to facilitate processing and forming shaped abrasive particles according to embodiments herein, the mixture 101 can have a particular viscosity. For example, the mixture 101 can have a viscosity of at least about 4×10³ Pa s, at least about 5×10³ Pa s, at least about 6×10³ Pa s, at least about 8×10³ Pa s, at least about 10×10³ Pa s, at least about 20×10³ Pa s, at least about 30×10³ Pa s, at least about 40×10³ Pa s, at least about 50×10³ Pa s, at least about 60×10³ Pa s, or even at least about 65×10³ Pa s. In at least one non-limiting embodiment, the mixture 101 may have a viscosity of not greater than about 1×10⁶ Pa s, not greater than about 5×10⁵ Pa s, not greater than about 3×10⁵ Pa s, or even not greater than about 2×10⁵ Pa s. It will be appreciated that the viscosity of the mixture 101 can be within a range between any of the minimum and maximum values noted above.

Moreover, the mixture 101 can be formed to have a particular content of organic materials, including for example, organic additives that can be distinct from the liquid, to facilitate processing and formation of shaped abrasive particles according to the embodiments herein. Some suitable organic additives can include stabilizers, binders, such as fructose, sucrose, lactose, glucose, UV curable resins, and the like.

Notably, the embodiments herein may utilize a mixture 101 that is distinct from slurries used in conventional tape casting operations. For example, the content of organic materials within the mixture 101, particularly, any of the organic additives noted above may be a minor amount as compared to other components within the mixture 101. In at least one embodiment, the mixture 101 can be formed to have not greater than about 30 wt % organic material for the total weight of the mixture 101. In other instances, the amount of organic materials may be less, such as not greater than about 15 wt %, not greater than about 10 wt %, or even not greater than about 5 wt %. Still, in at least one non-limiting embodiment, the amount of organic materials within the mixture 101 can be at least about 0.1 wt %, such as at least about 0.5 wt % for the total weight of the mixture 101. It will be appreciated that the amount of organic materials in the mixture 101 can be within a range between any of the minimum and maximum values noted above.

Moreover, the mixture 101 can be formed to have a particular content of acid or base distinct from the liquid, to facilitate processing and formation of shaped abrasive particles according to the embodiments herein. Some suitable acids or bases can include nitric acid, sulfuric acid, citric acid, chloric acid, tartaric acid, phosphoric acid, ammonium nitrate, ammonium citrate. According to one particular embodiment, the mixture 101 can have a pH of less than about 5, and more particularly, within a range between about 2 and about 4, using a nitric acid additive.

Referencing FIGS. 1A and 1B, the system 100 can include a die 103. As illustrated, the mixture 101 can be provided within the interior of the die 103 and configured to be extruded through a die opening 105 positioned at one end of the die 103. As further illustrated, forming can include applying a force 180 (that may be translated into a pressure) on the mixture 101 to facilitate moving the mixture 101 through the die opening 105. In accordance with an embodiment, a particular pressure may be utilized during extrusion, and such a pressure may be lower than certain pressures utilized during other forming processes, including for example traditional molding or printing operations. For example, the pressure can be at least about 10 kPa, such as at least about 150 kPa, at least about 200 kPa, at least 250 kPa, at least 300 kPa, at least 400 kPa, or even at least about 500 kPa. Still, in at least one non-limiting embodiment, the pressure utilized during extrusion can be not greater than about 4 MPa, not greater than about 1 MPa, not greater than 800 kPa, or even not greater than 500 kPa. It will be appreciated that the pressure used to extrude the mixture 101 can be within a range between any of the minimum and maximum values noted above. Further details of the die are provided in other embodiments herein.

In certain systems, the die 103 can include a die opening 105 having a particular shape. It will be appreciated that the die opening 105 may be shaped to impart a particular shape to the mixture 101 during extrusion. In accordance with an embodiment, the die opening 105 can have a rectangular shape. Furthermore, the mixture 101 extruded through the die opening 105 can have essentially the same cross-sectional shape as the die opening 105. As further illustrated, the mixture 101 may be extruded in the form of a sheet 111 and onto a belt 109 underlying the die 103. In specific instances, the mixture 101 can be extruded in the form of a sheet 111 directly onto the belt 109, which may facilitate continuous processing.

According to one particular embodiment, the belt can be formed to have a film overlying a substrate, wherein the film can be a discrete and separate layer of material configured to facilitate processing and forming of shaped abrasive particles. The process can include providing the mixture 101 directly onto the film of the belt to form the sheet 111. In certain instances, the film can include a polymer material, such as polyester. In at least one particular embodiment, the film can consist essentially of polyester. The film can be made of any material that may be formed integrally or coated on the belt 109. In at least one particular embodiment, the film can include a polymer that is extruded onto the belt 109 to form the substrate configured to receive the extruded sheet 111. Notably, the belt 109 can be made of an organic material, such as a polymer, including for example, polypropylene, polyimide, polyamide, fluoropolymers, and the like. In an alternative embodiment, the belt 109 can be made of an inorganic material, including for example, a metal or metal alloy, such as aluminum, steel, and the like. In at least one embodiment, the belt 109 can be made of a material having suitable flexibility to facilitate processing of the sheet 111.

In some embodiments, the belt 109 can be translated while moving the mixture 101 through the die opening 105. As illustrated in the system 100, the mixture 101 may be extruded in a direction 191. The direction of translation 110 of the belt 109 can be angled relative to the direction of extrusion 191 of the mixture. While the angle between the direction of translation 110 and the direction of extrusion 191 are illustrated as substantially orthogonal in the system 100, other angles are contemplated, including for example, an acute angle or an obtuse angle. Moreover, while the mixture 101 is illustrated as being extruded in a direction 191, which is angled relative to the direction of translation 110 of the belt 109, in an alternative embodiment, the belt 109 and mixture 101 may be extruded in substantially the same direction.

The belt 109 may be translated at a particular rate to facilitate processing. For example, the belt 109 may be translated at a rate of at least about 3 cm/s. In other embodiments, the rate of translation of the belt 109 may be greater, such as at least about 4 cm/s, at least about 6 cm/s, at least about 8 cm/s, or even at least about 10 cm/s. Still, in at least one non-limiting embodiment, the belt 109 may be translated in a direction 110 at a rate of not greater than about 5 m/s, not greater than about 1 m/s, or even not greater than about 0.5 m/s. It will be appreciated that the screen 151 may be translated at a rate within a range between any of the minimum and maximum values noted above.

For certain processes according to embodiments herein, the rate of translation of the belt 109 as compared to the rate of extrusion of the mixture 101 in the direction 191 may be controlled to facilitate proper processing. For example, the rate of translation of the belt 109 can be essentially the same as the rate of extrusion to ensure formation of a suitable sheet 111.

After the mixture 101 is extruded through the die opening 105, the mixture 101 may be translated along the belt 109 under a knife edge 107 attached to a surface of the die 103. The knife edge 107 may facilitate forming a sheet 111. More particularly, the opening defined between the surface of the knife edge 107 and belt 109 may define particular dimensions of the extruded mixture 101. For certain embodiments, the mixture 101 may be extruded in the form of a sheet 111 having a generally rectangular cross-sectional shape as viewed in a plane defined by a height and width of the sheet 111. While the extrudate is illustrated as a sheet, other shapes can be extruded, including for example cylindrical shapes and the like.

The process of forming the sheet 111 from the mixture 101 can include control of particular features and process parameters to facilitate suitable formation of shaped abrasive particles having one or more features as provided in the embodiments herein. For example, in certain instances, the process of forming a sheet 111 from the mixture 101 can include forming a sheet 111 having a particular height 181 controlled in part by a distance between the knife edge 107 and a surface of the belt 109. Moreover, it is noted that the height 181 of the sheet 111 can be controlled by varying a distance between the knife edge 107 and the surface of the belt 109. Additionally, forming the mixture 101 into the sheet 111 can include controlling the dimensions of the sheet 111 based in part upon the viscosity of the mixture 101. In particular, forming the sheet 111 can include adjusting the height 181 of the sheet 111 based on the viscosity of the mixture 101.

Furthermore, to facilitate processing and forming shaped abrasive particles according to embodiments herein, the mixture 101, and thus the sheet 111, can have a particular viscosity. For example, the mixture 101 can have a viscosity of at least about 4×10³ Pa s, at least about 5×10³ Pa s, at least about 6×10³ Pa s, at least about 8×10³ Pa s, at least about 10×10³ Pa s, at least about 20×10³ Pa s, at least about 30×10³ Pa s, at least about 40×10³ Pa s, at least about 50×10³ Pa s, at least about 60×10³ Pa s, or even at least about 65×10³ Pa s. In at least one non-limiting embodiment, the mixture 101 may have a viscosity of not greater than about 1×10⁶ Pa s, not greater than about 5×10⁵ Pa s, not greater than about 3×10⁵ Pa s, or even not greater than about 2×10⁵ Pa s. It will be appreciated that the viscosity of the mixture 101 can be within a range between any of the minimum and maximum values noted above. The viscosity can be measured in the same manner as the storage modulus as described above.

The sheet 11 can have particular dimensions, including for example a length (l), a width (w), and a height (h). In accordance with an embodiment, the sheet 111 may have a length that extends in the direction of the translating belt 109, which can be greater than the width, wherein the width of the sheet 111 is a dimension extending in a direction perpendicular to the length of the belt 109 and to the length of the sheet. The sheet 111 can have a height 181, wherein the length and width are greater than the height 181 of the sheet 111.

Notably, the height 181 of the sheet 111 can be the dimension extending vertically from the surface of the belt 109. In accordance with an embodiment, the sheet 111 can be formed to have a particular dimension of height 181, wherein the height may be an average height of the sheet 111 derived from multiple measurements. For example, the height 181 of the sheet 111 can be at least about 0.1 mm, such as at least about 0.5 mm. In other instances, the height 181 of the sheet 111 can be greater, such as at least about 0.8 mm, at least about 1 mm, at least about 1.2 mm, at least about 1.6 mm, or even at least about 2 mm. Still, in one non-limiting embodiment, the height 181 of the sheet 111 may be not greater than about 10 mm, not greater than about 5 mm, or even not greater than about 2 mm. It will be appreciated that the sheet 111 may have an average height within a range between any of the minimum and maximum values noted above.

According to one embodiment, the sheet 111 can have a length (l), a width (w), and a height (h), wherein the length≧width≧height. Moreover, the sheet 111 can have a secondary aspect ratio of length:height of at least about 10, such as at least about 100, at least about 1000, or even at least about 1000.

After extruding the mixture 101 from the die 103, the sheet 111 may be translated in a direction 112 along the surface of the belt 109. Translation of the sheet 111 along the belt 109 may facilitate further processing to form precursor shaped abrasive particles. For example, the sheet 111 may undergo a shaping process within the shaping zone 113. In particular instances, the process of shaping can include shaping a surface of the sheet 111, including for example, an upper major surface 117 of the sheet 111. In other embodiments, other major surfaces of the sheet may undergo shaping, including for example, the bottom surface or side surfaces. For certain processes, shaping can include altering a contour of the sheet through one or more processes, such as, embossing, rolling, cutting, engraving, patterning, stretching, twisting, and a combination thereof.

In one particular embodiment, the process of shaping can include forming a feature 119 in the upper major surface 117 of the sheet 111. More particularly, a shaping structure 115 may be contacted to the upper major surface 117 of the sheet 111 facilitating the formation of a feature 119 or a pattern of features in the upper major surface 117. It will be appreciated that the shaping structure 115 can take various forms, including for example, a roller having various features on its surface, wherein such features may be imparted to the upper major surface 117 of the sheet 111 upon contact between the shaping structure 115 and the upper major surface 117.

Still, it will be appreciated that alternative shaping structures and methods of shaping a sheet may be utilized. For example, the surface of the belt 109 may be textured such that features of the texture are imparted to the sheet 111, and the finally-formed shaped abrasive particles. Moreover, various devices may be used to impart a feature or pattern of features on the side surfaces of the sheet 111.

In accordance with an embodiment, the process of forming a shaped abrasive particle can further include translation of the sheet along the belt 109 through a forming zone 121. In accordance with an embodiment, the process of forming a shaped abrasive particle can include sectioning the sheet 111 to form precursor shaped abrasive particles 123. For example, in certain instances, forming can include perforating a portion of the sheet 111. In other instances, the process of forming can include patterning the sheet 111 to form a patterned sheet and extracting shapes from the patterned sheet.

Particular processes of forming can include cutting, pressing, punching, crushing, rolling, twisting, bending, drying, and a combination thereof. In one embodiment, the process of forming can include sectioning of the sheet 111. Sectioning of the sheet 111 can include the use of at least one mechanical object, which may be in the form of a gas, liquid, or solid material. The process of sectioning can include at least one or a combination of cutting, pressing, punching, crushing, rolling, twisting, bending, and drying. Moreover, it will be appreciated that sectioning can include perforating or creating a partial opening through a portion of the sheet 111, which may not extend through the entire height of the sheet 111.

For example, sectioning can include a water jet cutting process. In another embodiment, sectioning of the sheet 111 can include use of a mechanical object including one or a plurality of a blade, a wire, a disc, and a combination thereof. The blades may be oriented relative to each other in a variety of configurations to achieve the desired sectioning. For example, the blades may be arranged parallel to each other, such as in a ganged configuration. Alternatively, the mechanical object may include a set of spiral blades connected to each other or independent of each other.

Alternatively, the process of forming shaped abrasive particles can include the use of radiation to section the sheet 111 into discrete precursor shaped abrasive particles. For example, use of radiation may include the use of a laser to score or otherwise cut discrete shaped abrasive particles from the sheet 111.

It will be appreciated that at least one blade may be translated through the sheet 111 to facilitate sectioning. In particular instances, a sectioning process using a blade can include translating a blade in multiple directions including a first direction, and a second direction different than the first direction through the sheet 111. More notably, certain sectioning processes may utilize a plurality of blades that can be translated across and through the sheet 111 in multiple directions to facilitate the formation of precursor shaped abrasive particles 123.

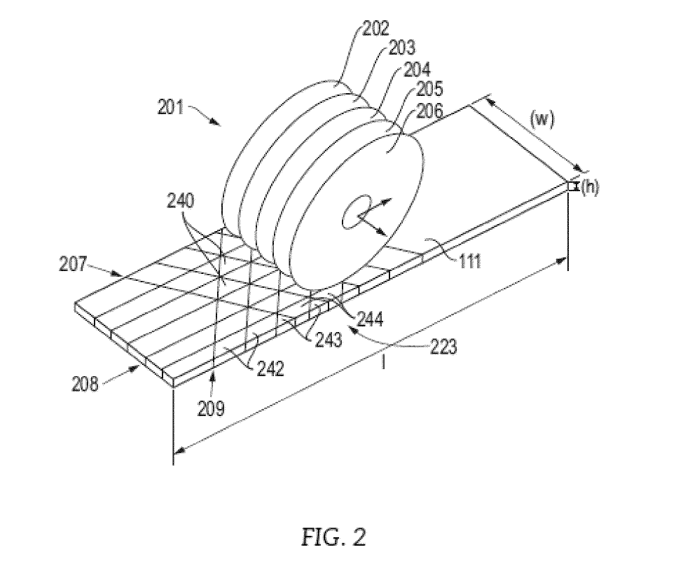

FIG. 2 includes an illustration of a particular device that may be utilized within the forming zone 121 to facilitate sectioning. As illustrated, the process of sectioning may include use of a cutting device 201 having a plurality of blades 202, 203, 204, 205, and 206 arranged in parallel to each other. The cutting device 201 can be translated in multiple directions through the sheet 111 to facilitate the formation of precursor shaped abrasive particles 123. For example, as illustrated in FIG. 2, the cutting device 201 may be translated first in a direction 207 angled with respect to the length (l) of the sheet 111. Thereafter, the cutting device 201 may be translated in a second direction 209 different that the first direction 207 and angled with respect to the first direction 207. Finally, the cutting device 201 may be translated across and through the sheet 111 in a third direction 208 that is different than the first direction 207 or second direction 209 to facilitate the formation of precursor shaped abrasive particles. While reference herein has noted that a single cutting device 201 may be translated in multiple directions, it will be appreciated that individual cutting devices may be utilized for discrete and individual cutting directions.

The process of sectioning can create different types of shaped abrasive particles in a single sectioning process. Different types of shaped abrasive particles can be formed from the same processes of the embodiments herein. Different types of shaped abrasive particles include a first type of shaped abrasive particle having a first two-dimensional shape and a second type of shaped abrasive particle having a different two-dimensional shape as compared to the first two-dimensional shape. Furthermore, different types of shaped abrasive particles may differ from each other in size. For example, different types of shaped abrasive particles may have different volumes as compared to each other. A single process which is capable of forming different types of shaped abrasive particles may be particularly suited for producing certain types of abrasive articles.

As further illustrated, upon sectioning of the sheet 111 with a cutting device 201, a plurality of precursor shaped abrasive particles may be formed in the sheet 111. In particular instances, as illustrated in FIG. 2, a first type of precursor shaped abrasive particles 240 can be formed from the sheet 111. The precursor shaped abrasive particles 240 may have a generally triangular shape two-dimensional shape as viewed in a plane defined by the length (l) and width (w) of the sheet 111.

Furthermore, the sectioning process may form another type of precursor shaped abrasive particles 243 approximate to, and even abutting, the edge of the sheet 111. The precursor shaped abrasive particles 243 can have a triangular two-dimensional shape as viewed in a plane defined by the length (l) and width (w) of the sheet 111. However, the precursor shaped abrasive particles 243 can be smaller in size as compared to the precursor shaped abrasive particles 240. In particular instances, the precursor shaped abrasive particles 243 can have a volume that is not greater than about 95% of the volume of the precursor shaped abrasive particles 240. Volume may be an average value calculated by the measurement of volume for at least 20 shaped abrasive particles of the same type. In other instances, the precursor shaped abrasive particles 243 can have a volume that is not greater than about 92%, not greater than about 90%, not greater than about 85%, such as not greater than about 80%, not greater than about 75%, not greater than about 60%, or even not greater than about 50% of the volume of the precursor shaped abrasive particles 240. Still, in one non-limiting embodiment, the precursor shaped abrasive particles 243 can have a volume that is at least about 10%, such as at least about 20%, at least about 30%, or even at least about 40% of the volume of the precursor shaped abrasive particles 240. The difference in volume between the precursor shaped abrasive particles 243 and precursor shaped abrasive particles 240 can be within a range between any of the minimum and maximum percentages noted above.

Another type of precursor shaped abrasive particles 242 may be formed in the same sectioning process used to form the precursor shaped abrasive particles 240 and 243 from the sheet 111. Notably, the precursor shaped abrasive particles 242 can have a quadrilateral two-dimensional shape as viewed in a plane defined by the width (w) and length (l) of the sheet 111. According to one particular embodiment, the precursor shaped abrasive particles 242 may have a two-dimensional shape of a parallelogram. It will be appreciated that the precursor shaped abrasive particles 242 can have a difference in volume as compared to the other precursor shaped abrasive particles as described in other embodiments herein.

The sectioning process may create another type of shaped abrasive particle 244 used to form the precursor shaped abrasive particles 240, 242, and 243 from the same sheet 111. Notably, the precursor shaped abrasive particles 244 can have a different two-dimensional polygonal shape as compared to the precursor shaped abrasive particles 240, 242, or 243. As illustrated in the embodiment of FIG. 2, the precursor shaped abrasive particles 244 can have a quadrilateral shape, and more particularly, a trapezoidal shape, as viewed in a plane defined by the width (w) and length (l) of the sheet 111. It will be appreciated that the precursor shaped abrasive particles 244 can have a difference in volume as compared to the other precursor shaped abrasive particles as described in other embodiments herein.

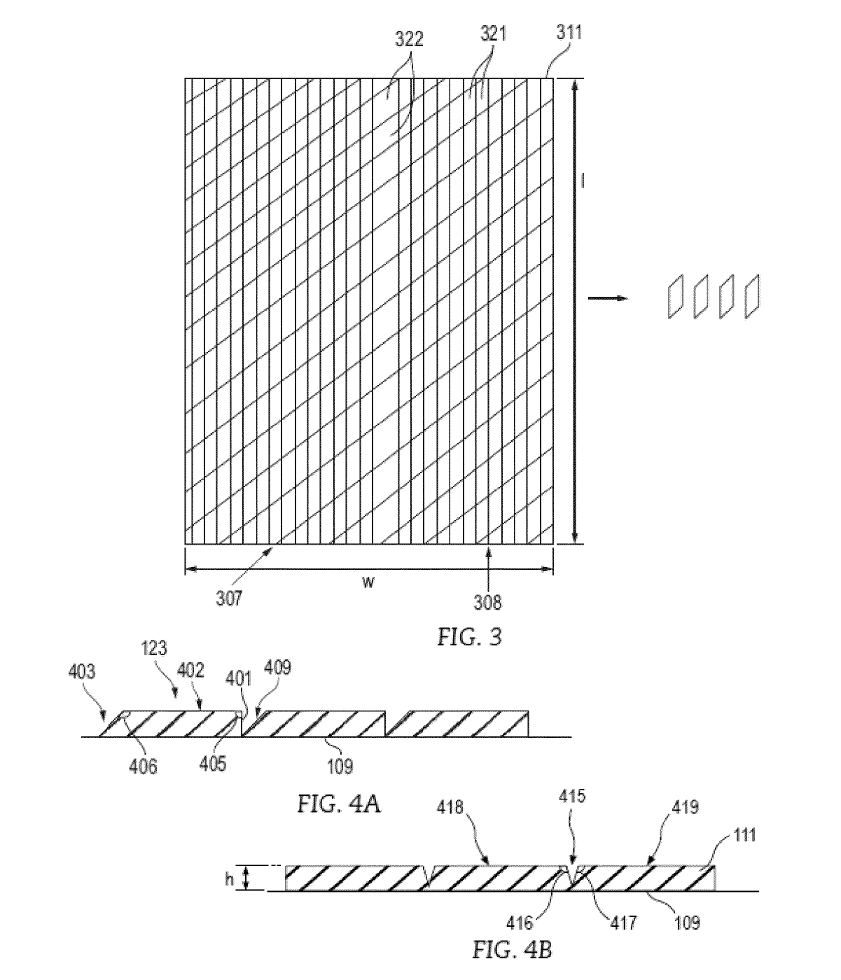

FIG. 3 includes an illustration of a portion of a sheet after a sectioning process in accordance with an embodiment. Notably, the sheet 111 can be cut in a first direction 308, and subsequently cut in a second direction 307 at an angle relative to the first direction 308. The sectioning process can create precursor shaped abrasive particles 321 having a generally quadrilateral polygonal shape as viewed in the plane defined by the length and width of the sheet 111. Furthermore, depending upon the sectioning process, a different type of precursor shaped abrasive particles 322 can be created in the same sectioning process used to create the precursor shaped abrasive particles 321. Notably, the precursor shaped abrasive particles 322 can be a different as compared to the precursor shaped abrasive particles 321 in terms of two-dimensional shape, size, and a combination thereof. For example, the precursor shaped abrasive particles 322 can have a greater volume as compared to the precursor shaped abrasive particles 321.

FIG. 4 includes a cross-sectional illustration of a portion of a sheet that has been formed into precursor shaped abrasive particles in accordance with an embodiment. Notably, as illustrated in FIG. 4, the precursor shaped abrasive particle 123 can be formed to have particular contours of side surfaces 401 and 403. In accordance with an embodiment, the precursor shaped abrasive particle 123 can have a first side surface 401 formed at a particular angle 405 to the upper surface 402. Likewise, the side surface 403 of the precursor shaped abrasive particle 123 can be joined to the upper surface 402 at a particular angle 406. Notably, the precursor shaped abrasive particle 123 can be formed such that the angle 405 formed between sidewall 401 and upper surface 402 can be different than the angle 406 formed between the sidewall 403 and upper surface 402. Various methods of forming shaped abrasive particles 123 having different angles 405 and 406 can include those methods described herein. In certain instances, a sectioning device may be angled relative to the upper major surface of the sheet to facilitate removal of the material at an angle relative to the plane of the belt and plane of the upper surface of each precursor shaped abrasive particle 123.

Sectioning can include moving the mechanical object through a portion of a sheet 111 and creating an opening within the sheet 111. Referring briefly to FIG. 4B, a cross-sectional illustration of a portion of a sheet after sectioning according to an embodiment is provided. In particular, the sheet 111 has an opening 415 extending into the volume of the sheet 111 and defined by surfaces 416 and 417. The opening 415 can define a cut extending through at least a fraction of the entire height (h) of sheet 111. It will be appreciated that the opening 415 does not necessarily need to extend through the full height of the sheet 111, and in particular instances, it may be suitable that the opening 409 in the sheet 111 is formed such that it does not extend through the entire height of the sheet 111.

In certain instances, the method of sectioning can include maintaining the opening 415 in the sheet 111. Maintaining the opening 415 after sectioning the sheet 111 has been sectioned by a mechanical object may facilitate suitable formation of shaped abrasive particles and features of shaped abrasive particles and features of a batch of shaped abrasive particles. Maintaining the opening 415 can include at least partially drying at least one surface of the sheet 111 defining the opening 415, including for example, one of the surfaces 416 and 417. The process of at least partially drying can include directing a drying material at the opening 415. A drying material may include a liquid, a solid, or even a gas. According to one particular embodiment, the drying material can include air.

Furthermore, the process of maintaining the opening 415 can include selectively directing a drying material, such as a gas, at the opening 415 and limiting the impingement of gas on other surfaces of the sheet 111, such as the surfaces 418 and 419 substantially spaced apart from the opening 415.

In certain instances, the process of sectioning can be conducted prior to sufficient drying of the sheet. For example, sectioning can be conducted prior to volatilization of not greater than about 20% of the liquid from the sheet 111 as compared to the original liquid content of the sheet during initial formation of the sheet 111. In other embodiments, the amount of volatilization allowed to occur before or during sectioning can be less, such as, not greater than about 15%, not greater than about 12%, not greater than about 10%, not greater than about 8%, or even not greater than about 4% of the original liquid content of the sheet.

As indicated by the description of embodiments herein, sectioning can be conducted simultaneously with the process of forming. Moreover, sectioning can be conducted continuously during the process of forming. Sectioning may not necessarily include a change in composition to the sheet, such as in the case of ablation processes, which rely upon vaporization.

According to one embodiment, sectioning can be conducted at particular conditions to facilitate the forming process. For example, sectioning can be conducted at controlled sectioning conditions including at least one of a controlled humidity, a controlled temperature, a controlled air pressure, a controlled air flow, a controlled environmental gas composition, and a combination thereof. Control of such conditions may facilitate control of the drying of the sheet and facilitate formation of shaped abrasive particles having particular features. According to a particular embodiment, sectioning can include monitoring and control of one or more certain environmental conditions, including but not limited to humidity, temperature, air pressure, air flow, environmental gas composition, and a combination thereof,

For at least one embodiment, the temperature of the environment used for sectioning (i.e., sectioning temperature) that can be controlled relative to the temperature of the environment used in other processes. For example, the sectioning temperature can be conducted at a substantially different temperature as compared to the temperature used during forming (e.g., extruding) of the sheet. Alternatively, the temperature used during forming of the sheet can be substantially the same as the sectioning temperature. Moreover, in another embodiment, the mechanical object can have a temperature greater than a temperature of the sheet 111 during sectioning. In an alternative condition, the mechanical object can have a temperature less than a temperature of the sheet 111.

For another aspect, the process of sectioning can include providing at least one opening agent to an opening formed in the sheet 111 after sectioning, wherein the opening agent is sufficient to maintain an opening in the sheet after sectioning. Some suitable methods of providing the opening agent can include depositing, coating, spraying, printing, rolling, transferring, and a combination thereof. In one particular embodiment, the mechanical object can be coated with a least one opening agent, wherein the opening agent can be transferred from a surface of the mechanical object to a surface of the sheet defining the opening. The opening agent can include a material selected from the group of inorganic materials, organic materials, polymers, and a combination thereof. In one embodiment, the opening agent may be a foaming agent, surfactant, and a combination thereof.

Referring again to FIGS. 1A and 1B, after forming precursor shaped abrasive particles 123, the particles may be translated through a post-forming zone 125. Various processes may be conducted in the post-forming zone 125, including for example, heating, curing, vibration, impregnation, doping, and a combination thereof.

In one embodiment, the post-forming zone 125 includes a heating process, wherein the precursor shaped abrasive particles 123 may be dried. Drying may include removal of a particular content of material, including volatiles, such as water. In accordance with an embodiment, the drying process can be conducted at a drying temperature of not greater than 300° C. such as not greater than 280° C. or even not greater than about 250° C. Still, in one non-limiting embodiment, the drying process may be conducted at a drying temperature of at least 50° C. It will be appreciated that the drying temperature may be within a range between any of the minimum and maximum temperatures noted above.

Furthermore, the precursor shaped abrasive particles 123 may be translated through a post-forming zone at a particular rate, such as at least about 0.2 feet/min and not greater than about 8 feet/min. Furthermore, the drying process may be conducted for a particular duration. For example, the drying process may be not greater than about six hours.

After the precursor shaped abrasive particles 123 are translated through the post-forming zone 125, the particles may be removed from the belt 109. The precursor shaped abrasive particles 123 may be collected in a bin 127 for further processing.

In accordance with an embodiment, the process of forming shaped abrasive particles may further comprise a sintering process. The sintering process can be conducted after collecting the precursor shaped abrasive particles 123 from the belt 109. Sintering of the precursor shaped abrasive particles 123 may be utilized to densify the particles, which are generally in a green state. In a particular instance, the sintering process can facilitate the formation of a high-temperature phase of the ceramic material. For example, in one embodiment, the precursor shaped abrasive particles 123 may be sintered such that a high-temperature phase of alumina, such as alpha alumina is formed. In one instance, a shaped abrasive particle can comprise at least about 90 wt % alpha alumina for the total weight of the particle. In other instances, the content of alpha alumina may be greater, such that the shaped abrasive particle may consist essentially of alpha alumina.

The body of the shaped abrasive particles may include additives, such as dopants, which may be in the form of elements or compounds (e.g., oxides). Certain suitable additives can include alkali elements, alkaline earth elements, rare-earth elements, hafnium (Hf), zirconium (Zr), niobium (Nb), tantalum (Ta), molybdenum (Mo), and a combination thereof. In particular instances, the additive can include an element such as lithium (Li), sodium (Na), potassium (K), magnesium (Mg), calcium (Ca), strontium (Sr), barium (Ba), scandium (Sc), yttrium (Y), lanthanum (La), cesium (Ce), praseodymium (Pr), niobium (Nb), hafnium (Hf), zirconium (Zr), tantalum (Ta), molybdenum (Mo), vanadium (V), chromium (Cr), cobalt (Co), iron (Fe), germanium (Ge), manganese (Mn), nickel (Ni), titanium (Ti), zinc (Zn), and a combination thereof.

The body of a shaped abrasive article may include a specific content of additive (e.g., dopant). For example, the body of a shaped abrasive particle may include not greater than about 12 wt % additive for the total weight of the body. In still other embodiments, they amount of additive may be less, such as not greater than about 11 wt %, not greater than about 10 wt %, not greater than about 9 wt %, not greater than about 8 wt %, not greater than about 7 wt %, not greater than about 6 wt %, or even not greater than about 5 wt %. Still, the amount of additive in at least one non-limiting embodiment can be at least about 0.5 wt %, such as at least about 1 wt %, at least about 1.3 wt %, at least about 1.8 wt %, at least about 2 wt %, at least about 2.3 wt %, at least about 2.8 wt %, or even at least about 3 wt %. It will be appreciated that the amount of additive within a body of a shaped abrasive particle may be within a range between any of the minimum and maximum percentages noted above.

While the process illustrated in the system 100 has described a shaping process conducted in a shaping zone 113 followed by a forming process at the forming zone 121, and a post-forming process in a post-forming zone, other orders of the processes and zones are contemplated. For example, the process of shaping a surface of the sheet 111 can be conducted after a forming process. In still other instances, the forming process may be completed during the forming process, such that the forming process and shaping process are completed simultaneously. Moreover, while certain processes have been illustrated as being integral with a belt translation system, any of the processes described herein may be completed independent of each other and the belt translation system.

The shaped abrasive particles of the embodiments herein can have a body defined by a length (l), a width (w), and a height (h), wherein w≧l≧h. The body can include a width (w) that is the longest dimension of the body and extending along a side of the particle. The body may further include a length (l) that can be a dimension extending through a portion of the body, such as the midpoint, or alternatively, may be a dimension extending between particular points on the outer surface of the body (e.g., between opposing corners). It will be appreciated that the body can have a variety of length dimensions depending upon the points of reference. Additionally, the shaped abrasive particle can further include a height (h), which may be a dimension of the shaped abrasive particle extending in a direction substantially perpendicular to the length and width in a direction defined by a side surface of the body 301. Notably, as will be described in more detail herein, the body 301 can be defined by various heights depending upon the location on the body. In specific instances, the width can be greater than or equal to the length, the length can be greater than or equal to the height, and the width can be greater than or equal to the height.

Additionally, the body of a shaped abrasive particle of the embodiments herein can have various two-dimensional shapes. For example, the body can have a two-dimensional shape as viewed in a plane define by the length and width having a polygonal shape, ellipsoidal shape, a numeral, a Greek alphabet character, Latin alphabet character, Russian alphabet character, complex shapes utilizing a combination of polygonal shapes and a combination thereof. Particular polygonal shapes include triangular (e.g., equilateral triangle), rectangular, quadrilateral, pentagon, hexagon, heptagon, octagon, nonagon, decagon, any combination thereof.

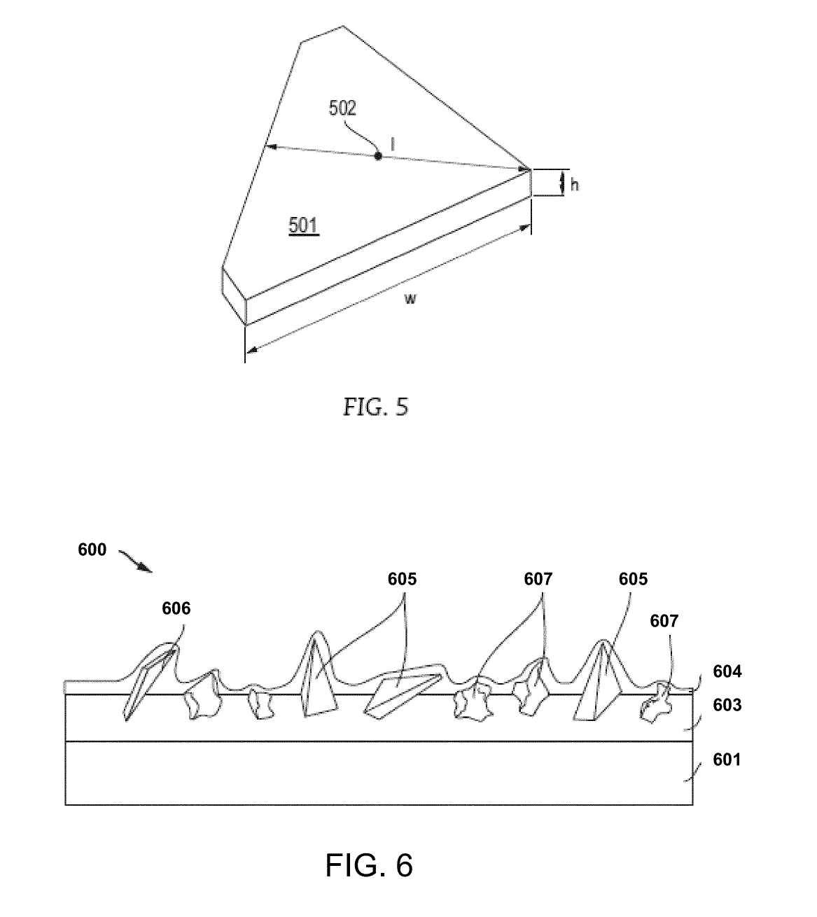

FIG. 5 includes a perspective view illustration of a shaped abrasive particle in accordance with an embodiment. As illustrated, the shaped abrasive particle can have a corner-truncated triangular shape. In particular, the body 501 of the shaped abrasive particle can have a width (w) extending along a side surface of the body 501, a length extending through a midpoint 502 of the body 501, and a height (h). In accordance with an embodiment, the body 501 can have a primary aspect ratio defined as a ratio of width:length. In certain instances, the primary aspect ratio of the body 501 can be at least about 1:1, such as at least about 1.2:1, such as at least about 1.5:1, at least about 2:1, at least about 3:1, or even at least about 4:1. Still, the primary aspect ratio may be not greater than about 100:1. It will be appreciated that the primary aspect ratio of the body 501 may be within a range between any of the minimum and maximum ratios noted above. The dimensions used to calculate the primary aspect ratio may be based upon a median value of a batch of shaped abrasive particles. For example, the length can be based upon a median profile length for a batch of shaped abrasive particles.

Furthermore, the body 501 can have a secondary aspect ratio defined by a ratio of width:height. In certain instances, the secondary aspect ratio of the body 501 may be at least about 1.2:1, such as at least about 1.5:1, at least about 2:1, at least about 3:1, at least about 4:1, at least about 5:1, or even at least about 10:1. Still, in at least one non-limiting embodiment, the body 501 can have a secondary aspect ratio that is not greater than about 100:1. It will be appreciated that the secondary aspect ratio may be within a range between any of the minimum and maximum ratios provided above. The dimensions used to calculate the secondary aspect ratio may be based upon a median value of a batch of shaped abrasive particles. For example, the height can be based upon a median interior height for a batch of shaped abrasive particles.

Furthermore, the shaped abrasive particles of the embodiments herein can have a tertiary aspect ratio defined by a ratio of the length:height. In certain instances, the tertiary aspect ratio of the body 501 may be at least about 1.2:1, such as at least about 1.5:1, at least about 2:1, at least about 3:1, at least about 4:1, at least about 5:1, or even at least about 10:1. Still, in at least one non-limiting embodiment, the body 501 can have a tertiary aspect ratio that is not greater than about 100:1. It will be appreciated that the tertiary aspect ratio may be within a range between any of the minimum and maximum ratios provided above. The dimensions used to calculate the tertiary aspect ratio may be based upon a median value of a batch of shaped abrasive particles. For example, the height can be based upon a median interior height for a batch of shaped abrasive particles.

The method of the embodiment herein may be suitable for the formation of very small shaped abrasive particles. Notably, the sectioning process may be controlled in such a manner that very fine sizes of shaped abrasive particles, having substantially the same two-dimensional shape and dimensions relative to each other can be created. For example, in one embodiment, the method can be controlled in such a manner that shaped abrasive particles, such as in the form of triangles can be created having a shape that is smaller than can be achieved through conventional molding operations, which rely on the ability to create a cavity within a production tool. By contrast, the method of the present embodiments can facilitate the formation of shaped abrasive particles, wherein the longest dimension (e.g., the width along a side of the triangle as the greatest dimension) can be less than 1.5 mm, such as not greater than 1.3 mm, not greater than 1.2 mm, not greater than 1 mm, not greater than 0.95 mm, not greater than 0.9 mm, not greater than 0.85 mm, not greater than 0.8 mm, not greater than 0.75 mm, or even not greater than 0.6 mm. Still, it will be appreciated that in one non-limiting embodiment, the width (i.e., longest dimension) of the body of the shaped abrasive particle can be at least about 0.01 mm, at least 0.05 mm, or even at least 0.1 mm. It will be appreciated that the width of the body can be within a range including any of the minimum and maximum values noted above, including for example, within a range including at least 0.01 mm and not greater than 1.3 mm, or within a range including at least 0.05 mm and not greater than 1 mm, or even within a range including at least 0.1 mm and not greater than 0.9 mm.

Furthermore, the method may be practiced with such control that a batch of shaped abrasive particles of different sizes and different shapes is created simultaneously. For example, the process can be used to create a batch of shaped abrasive particles of a first shape including truncated triangles (as viewed top-down in two dimensions) and fine triangles (as viewed top-down in two-dimensions) can be formed from the portions removed (i.e., truncated portions) from the larger truncated triangles.

FIG. 6 includes a cross-sectional illustration of a coated abrasive article incorporating the abrasive particulate material in accordance with an embodiment. As illustrated, the coated abrasive 600 can include a substrate 601 and a make coat 603 overlying a surface of the substrate 601. The coated abrasive 600 can further include a first type of abrasive particulate material 605 in the form of a first type of shaped abrasive particle, a second type of abrasive particulate material 606 in the form of a second type of shaped abrasive particle, and a third type of abrasive particulate material in the form of diluent abrasive particles, which may not necessarily be shaped abrasive particles, and having a random shape. The coated abrasive 600 may further include size coat 604 overlying and bonded to the abrasive particulate materials 605, 606, 607, and the make coat 604.

According to one embodiment, the substrate 601 can include an organic material, inorganic material, and a combination thereof. In certain instances, the substrate 601 can include a woven material. However, the substrate 601 may be made of a non-woven material. Particularly suitable substrate materials can include organic materials, including polymers, and particularly, polyester, polyurethane, polypropylene, polyimides such as KAPTON from DuPont, paper. Some suitable inorganic materials can include metals, metal alloys, and particularly, foils of copper, aluminum, steel, and a combination thereof.

The make coat 603 can be applied to the surface of the substrate 601 in a single process, or alternatively, the abrasive particulate materials 605, 606, 607 can be combined with a make coat 603 material and applied as a mixture to the surface of the substrate 601. Suitable materials of the make coat 603 can include organic materials, particularly polymeric materials, including for example, polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof. In one embodiment, the make coat 603 can include a polyester resin. The coated substrate can then be heated in order to cure the resin and the abrasive particulate material to the substrate. In general, the coated substrate 601 can be heated to a temperature of between about 100° C. to less than about 250° C. during this curing process.

The abrasive particulate materials 605, 606, and 607 can include different types of shaped abrasive particles according to embodiments herein. The different types of shaped abrasive particles can differ from each other in composition, two-dimensional shape, three-dimensional shape, size, and a combination thereof as described in the embodiments herein. As illustrated, the coated abrasive 600 can include a first type of shaped abrasive particle 605 having a generally triangular two-dimensional shape and a second type of shaped abrasive particle 606 having a quadrilateral two-dimensional shape. The coated abrasive 600 can include different amounts of the first type and second type of shaped abrasive particles 605 and 606. It will be appreciated that the coated abrasive may not necessarily include different types of shaped abrasive particles, and can consist essentially of a single type of shaped abrasive particle. As will be appreciated, the shaped abrasive particles of the embodiments herein can be incorporated into various fixed abrasives (e.g., bonded abrasives, coated abrasive, non-woven abrasives, thin wheels, cut-off wheels, reinforced abrasive articles, and the like), including in the form of blends, which may include different types of shaped abrasive particles, shaped abrasive particles with diluent particles, and the like. Moreover, according to certain embodiments, batch of particulate material may be incorporated into the fixed abrasive article in a predetermined orientation, wherein each of the shaped abrasive particles can have a predetermined orientation relative to each other and relative to a portion of the abrasive article (e.g., the backing of a coated abrasive).

The abrasive particles 607 can be diluent particles different than the first and second types of shaped abrasive particles 605 and 606. For example, the diluent particles can differ from the first and second types of shaped abrasive particles 605 and 606 in composition, two-dimensional shape, three-dimensional shape, size, and a combination thereof. For example, the abrasive particles 607 can represent conventional, crushed abrasive grit having random shapes. The abrasive particles 607 may have a median particle size less than the median particle size of the first and second types of shaped abrasive particles 605 and 606.

After sufficiently forming the make coat 603 with the abrasive particulate materials 605, 606, 607 contained therein, the size coat 604 can be formed to overlie and bond the abrasive particulate material 605 in place. The size coat 604 can include an organic material, may be made essentially of a polymeric material, and notably, can use polyesters, epoxy resins, polyurethanes, polyamides, polyacrylates, polymethacrylates, poly vinyl chlorides, polyethylene, polysiloxane, silicones, cellulose acetates, nitrocellulose, natural rubber, starch, shellac, and mixtures thereof.

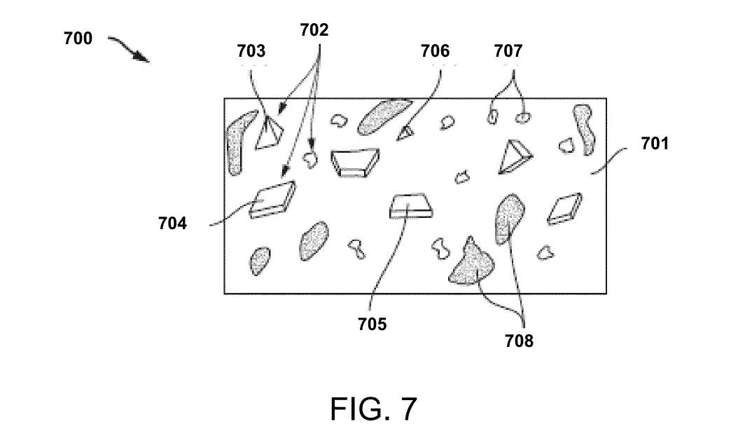

FIG. 7 includes an illustration of a bonded abrasive article incorporating the abrasive particulate material in accordance with an embodiment. As illustrated, the bonded abrasive 700 can include a bond material 701, abrasive particulate material 702 contained in the bond material, and porosity 708 within the bond material 701. In particular instances, the bond material 701 can include an organic material, inorganic material, and a combination thereof. Suitable organic materials can include polymers, such as epoxies, resins, thermosets, thermoplastics, polyimides, polyamides, and a combination thereof. Certain suitable inorganic materials can include metals, metal alloys, vitreous phase materials, crystalline phase materials, ceramics, and a combination thereof.

The abrasive particulate material 702 of the bonded abrasive 700 can include different types of shaped abrasive particles 703, 704, 705, and 706, which can have any of the features of different types of shaped abrasive particles as described in the embodiments herein. Notably, the different types of shaped abrasive particles 703, 704, 705, and 706 can differ from each other in composition, two-dimensional shape, three-dimensional shape, size, and a combination thereof as described in the embodiments herein.

The bonded abrasive 700 can include a type of abrasive particulate material 707 representing diluent abrasive particles, which can differ from the different types of shaped abrasive particles 703, 704, 705, and 706 in composition, two-dimensional shape, three-dimensional shape, size, and a combination thereof.

The porosity 708 of the bonded abrasive 700 can be open porosity, closed porosity, and a combination thereof. The porosity 708 may be present in a majority amount (vol %) based on the total volume of the body of the bonded abrasive 700. Alternatively, the porosity 708 can be present in a minor amount (vol %) based on the total volume of the body of the bonded abrasive 700. The bond material 701 may be present in a majority amount (vol %) based on the total volume of the body of the bonded abrasive 700. Alternatively, the bond material 701 can be present in a minor amount (vol %) based on the total volume of the body of the bonded abrasive 700. Additionally, abrasive particulate material 702 can be present in a majority amount (vol %) based on the total volume of the body of the bonded abrasive 700. Alternatively, the abrasive particulate material 702 can be present in a minor amount (vol %) based on the total volume of the body of the bonded abrasive 700.

In another embodiment the method of forming a shaped abrasive particle includes forming a mixture comprising a ceramic material into a sheet and sectioning at least a portion of the sheet using a mechanical object and forming at least one shaped abrasive particle from the sheet, wherein sectioning includes controlling at least one process parameter selected from the group consisting of an extrusion height, a sheet moisture content, a sheet solids loading, an orientation of the sheet during sectioning, a pressure differential during sectioning, a blade spacing variation, a blade edge thickness, a ratio of blade edge thickness to blade spacing variation, and a combination thereof.

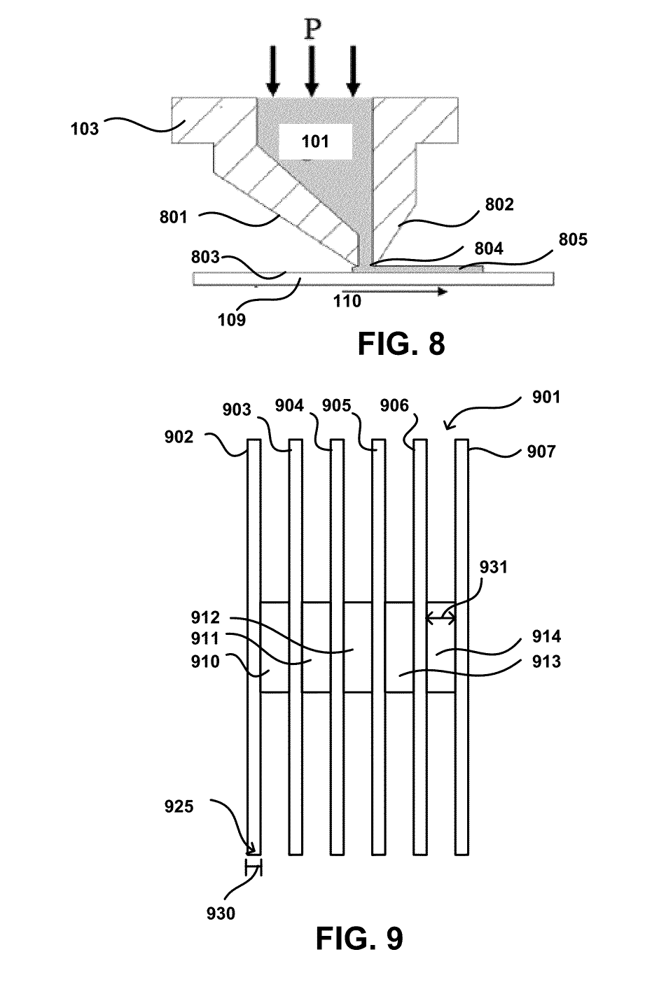

As noted herein, the process can include extruding a mixture in the form of a sheet onto a belt. Referring to FIG. 8, a side view of a portion of a die and extruding process are illustrated according to an embodiment. In particular, FIG. 8 includes an illustration of a mixture 101 contained within a die 103 and being extruded from an opening in the die 103. In particular instances, the mixture 101 can be extruded from the die 103 in the form of a sheet 805. The mixture 101 can be extruded from the die 103 onto a surface of the belt 109 while the belt is being translated in the direction 110 to facilitate formation of the mixture 101 into a sheet 805 overlying the belt 109. According to one embodiment, the die 103 can have tapered walls 801 and 802 defining the bottom portion of the die 103 to facilitate improved delivery of the mixture 101 onto the belt 109 and formation of a sheet 805.

According to one particular embodiment, extruding can include controlling an extrusion height defining a distance between an upper surface 803 of the belt 109 and a bottom surface 804 of the die 103. Control of the extrusion height can facilitate control of the dimensions of the sheet 805, including, but not limited to, the height of the sheet 805 as defined in other embodiments herein. Notably, control of the extrusion height may facilitate formation of a sheet having suitable height uniformity, particularly for a mixture 101 having the viscosity and solids content according to the embodiments herein, which has been found to be suitable for the formation of shaped abrasive particles. Moreover, the extrusion height may correspond to the height of the sheet 805, such that the height of the sheet 805 and the extrusion height are substantially the same relative to each other. Substantially the same can refer to values that are not greater than about 5% different compared to each other by the formula ((V1−V2)/V1), wherein V1 represents a value (e.g., extrusion height) greater than V2 (e.g., height of the sheet).

For at least one embodiment, the extrusion height can be greater than zero, such that the upper surface 803 of the belt 109 is spaced apart from the bottom surface 804 of the die 103. That is, at least some gap or space may be present between the upper surface 803 of the belt 109 and the bottom surface 804 of the die 103. In yet another embodiment, the extrusion height can be at least about 0.5(h), wherein “h” represents the height of the sheet 805, such as at least about 0.7(h), or even at least about 0.9(h). Still, in at least one embodiment, the extrusion height can be not greater than about 3(h), such as not greater than about 2.5(h) or not greater than about 2(h). In one instance, the extrusion height can be substantially the same as the height of the sheet 805. It will be appreciated that the extrusion height can be within a range including any of the minimum or maximum values noted above. For example, the extrusion height can be at least about 0.5(h) and not greater than about 3(h).

After suitably forming the sheet 805, the process may continue by forming precursor shaped abrasive particles from the sheet by sectioning. In at least one instance, sectioning can include completely separating a first portion of the sheet 805 from a second portion of the sheet 805. That is, sectioning can include a complete cut through the entire height of the sheet 805 that sections and separates a first portion from a second portion of the sheet.

In yet another embodiment, the sectioning can include creating a channel partially separating a first portion of the sheet 805 from a second portion of the sheet 805. The channel may not necessarily extend for the entire height of the sheet 805 and therefore may not necessarily completely separate the first portion and second portions from each other. Formation of a channel can include partial sectioning of the sheet, such that the entire height of the sheet is not cut completely through, but rather only a portion of the entire thickness of the sheet is reduced in height to define first and second portions that will be completely separated from each other by later processing. The channel can have a height less than an entire height of the first portion and second portion of the sheet 805.

It was surprisingly discovered that in certain processes, partial sectioning of the sheet, or the formation of channels, may actually produce shaped abrasive particles having improved shape uniformity and dimensional features. For example, sectioning may include formation of a channel between a first portion and a second portion, wherein the channel has an average height of not greater than about 50% of the average height of the sheet prior to sectioning. In other instances, sectioning may include formation of a channel between a first portion and a second portion, wherein the channel has an average height of not greater than about 45% of the average height of the sheet prior to sectioning, such as not greater than about 40%, not greater than about 30%, not greater than about 20%, or even not greater than about 10%. Still, in at least one embodiment, sectioning may include formation of a channel having an average height of at least about 0.1% or even at least about 1% of the average height of the sheet prior to sectioning. It will be appreciated that the height of a channel can be within a range including any of the minimum or maximum values noted above, including for example, a channel with a height of at least about 0.1% and not greater than about 50% of the average height of the sheet prior to sectioning.

Furthermore, in certain instances, sectioning may be conducted on at least a portion of the sheet having a particular moisture content to facilitate proper formation of the shaped abrasive particles, while also limiting post-formation defects that may occur due to cracking and/or excessive shrinkage. According to one embodiment, sectioning of the sheet can be conducted on a portion of the sheet having a moisture content of at least 10% (Cm0), wherein “Cm0” represents the moisture content of the sheet during forming, including for example, the moisture content of the mixture 101 during extrusion. Notably, in another embodiment, sectioning can be conducted on a portion of the sheet having a moisture content of at least about 30% (Cm0), at least about 50% (Cm0), at least about 75% (Cm0), at least about 85% (Cm0), at least about 90% (Cm0) or even at least about 95% (Cm0). Still, in another non-limiting embodiment, the sectioning may be conducted on at least a portion of the sheet having a moisture content (e.g., liquid content as described herein) that is substantially the same as the moisture content of the mixture during forming. It will be appreciated that the moisture content of the sheet during sectioning can be within a range including any of the minimum or maximum values noted above, including for example, at least about 10% (Cm0) and not greater than about 100% (Cm0). Moreover, it will be appreciated that the moisture content can be the same as the liquid volume percentage of the mixture.

In certain processes, sectioning can include applying a pressure differential to at least a portion of the sheet during sectioning. Application of the pressure differential may provide a suitable manner of holding the sheet and limiting movement of the sheet during sectioning, which may facilitate formation of shaped abrasive particles having greater shape consistency and overall shape features. Suitable methods of applying a pressure differential can include use of a vacuum table during sectioning, wherein the belt 109 may include perforations and the vacuum table can provide a pressure differential suitable to secure the sheet 805 against the belt 109 and limiting movement of the sheet 805 in at least one direction, including lateral, longitudinal, and rotational directions during sectioning.

According to one embodiment, sectioning can include translating a plurality of blades through at least a portion of the sheet 805 as described in embodiments herein. FIG. 9 includes an image of a mechanism including a plurality of blades according to an embodiment. As illustrated, the mechanism 901 can include a plurality of blades, including blades 902, 903, 904, 905, 906, and 907, (902-907) which are separated from each other by a plurality of spacers including spacers 910, 911, 912, 913, and 914 (910-914). As illustrated, the plurality of blades 902-907 can be arranged in a gang configuration, which may provide capability of sectioning larger areas of the sheet at one time.

In at least one embodiment, the plurality of blades 902-907 can be separated by a plurality of blade spacers 910-914 having one or more controlled dimensions, including for example, the spacer width 931 to facilitate formation of a plurality of shaped abrasive particles having high uniformity in shape. It has been discovered that control of the spacer width 931 can facilitate efficient formation of shaped abrasive particles having high shape uniformity. More particularly, the plurality of blade spacers 910-914 can each have a spacer width and define a blade spacer variation. The blade spacer variation is the standard deviation of the spacer widths of the plurality of blade spacers 910-914. In at least one embodiment, the blade spacer variation can be not greater than about 0.01, such as not greater than about 0.009, or even not greater than about 0.005. Still, in one non-limiting embodiment, the blade spacer variation may be at least about 0.00001. It will be appreciated that the blade spacer variation can be within a range including any of the minimum and maximum values noted above.

As further illustrated in FIG. 9, each of the blades of the plurality of blades 902-907 can have a blade edge 925 defining a shape of the end of the blade 902. Notably, the blade edge 925 can be a portion of the blade that conducts the sectioning and is configured to contact the sheet 805 during sectioning. In at least one embodiment, the blade edge 925 can be a dulled tip as viewed in cross-section, such as shown in FIG. 9. That is, it has been surprisingly discovered, that utilizing a blade edge 925 having a dulled tip, as opposed to a sharpened tip that defines a sharp point, can facilitate improved formation of shaped abrasive particles having improved shape uniformity. A dulled tip can be defined by a rounded edge, having a radius defined by a best fit circle that is equivalent to at least 0.1(t), wherein “t” is the thickness of a blade or average thickness of the plurality of blades 902-907. The thickness of the blade is understood to define a dimension extending between the major surfaces of the blades in an axial direction. In yet another embodiment, the dulled tip can have a rounded shape defining a radius of curvature of at least about 0.2(t), at least about 0.3(t), at least about 0.4(t), at least about 0.5(t), at least about 0.6(t), at least about 0.8(t), at least about 1(t). Still, in a non-limiting embodiment, the dulled tip can have a rounded shape defining a radius of curvature of not greater than about 5(t), such as not greater than about 4(t), not greater than about 2(t). It will be appreciated that the dulled tip can have a rounded shape defining a radius of curvature within a range including any of the minimum and maximum values noted above.

For another embodiment, at least one blade edge 925 of the plurality of blade edges 902-907 can be a dulled tip having a polygonal shape, such as a squared edge. In particular, at least one blade edge 925 can have a squared contour, such as illustrated in FIG. 9. It will be appreciated that other variation are possible and some tapering of the blade may be utilized but maintain a dulled tip.

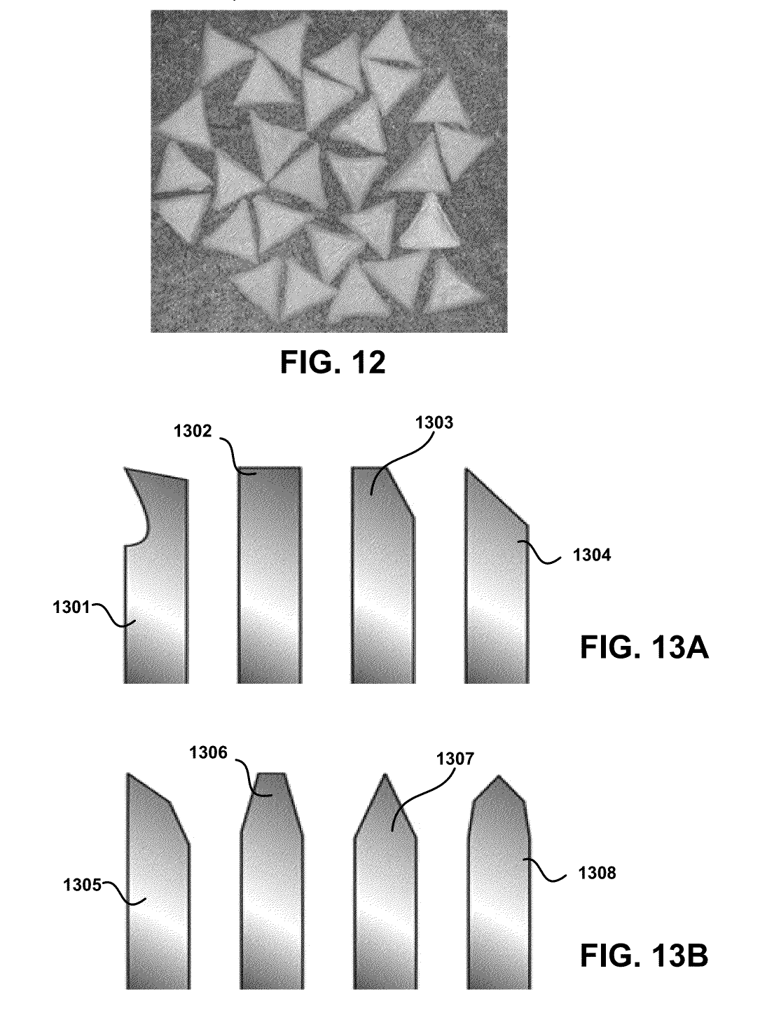

FIGS. 13A and 13B include cross-sectional illustrations of blade edges that may be used in the process of the embodiments herein. Blade 1301 includes a blade edge shape having a single bevel with an undercut. Blade 1302 includes a square blade edge shape. Blade 1303 includes a blade edge shape having a single bevel with a flat tip portion. Blade 1304 includes a blade edge shape having a single bevel with a sharp tip, which may be used to produce the cuts illustrated in FIG. 4A. Blade 1305 includes a blade edge shape having a compound single bevel with a sharp tip on one side of the blade. Blade 1306 includes a blade edge shape having a double bevel with a blunt or dull tip defining a planar region at the tip. Blade 1307 includes a blade edge shape having a double bevel with a sharp tip that is substantially in the center of the thickness of the blade. Blade 1308 includes a blade edge shape having a compound double bevel with a sharp tip that is substantially in the center of the thickness of the blade.

Moreover, at least one of the blades of the plurality blades 902-907 can have a particular blade edge thickness 930 that facilitates improved formation of shaped abrasive particles having improved shape features and uniformity of shape. The blade edge thickness 930 is the width of the blade at the edge 925. It will be appreciated that reference to a blade edge thickness can be an average blade edge thickness for the plurality of blades 902-907. According to one embodiment, the blade edge thickness can be at least 0.001 mm, such as at least about 0.01 mm, at least about 0.02 mm, at least about 0.05 mm, or even at least about 0.1 mm thick. Still, in another non-limiting embodiment, the blade edge thickness can be not greater than about 3 mm. It will be appreciated that the blade edge thickness can have a value within a range including any of the minimum and maximum values noted above.

It has also been surprisingly noted that sectioning may be improved by control of a relationship between the blade edge thickness (BET) and the blade spacing variation (BSV). The control of the relationship between the blade edge thickness (BET) and the blade spacing variation (BSV) can facilitate improved formation of shaped abrasive particles having improved shape features and uniformity of shaped abrasive particles compared to each other. As noted herein, the plurality of blades 902-907 can define an average blade edge thickness (BET) and the plurality of blades 902-907 can be separated from each other by blade spacers defining a blade spacing variation (BSV). In one embodiment, the mechanism 901 can be formed such that the average blade edge thickness (BET) is greater than the blade spacing variation (BSV). More particularly, the mechanism 901 can define a ratio (BET:BSV) of blade edge thickness to blade spacing variation of at least about 2:1, such as at least about 3:1, at least about 4:1, at least about 5:1, at least about 6:1, at least about 7:1, at least about 8:1, at least about 9:1 or even at least about 10:1. Still, in one particular instance, the blade edge thickness can be at least one order of magnitude greater than the blade spacing variation. For at least one non-limiting embodiment, the ratio (BET:BSV) can be not greater than about 1×10⁶:1 not greater than about 1×10⁵:1, or not greater than about 5000:1 It will be appreciated that the ratio (BET:BSV) can be within a range including the minimum and maximum values noted above.

In other conventional sectioning processes the shaped abrasive particles demonstrated variability in shape of up to 43% of the entire batch of shaped abrasive particles formed. That is, for example, for a batch of shaped abrasive particles sectioned from a sheet and intended to have a triangular two-dimensional shape up to 43% of the particles had a non-triangular shape (e.g., a truncated polygonal shape). According to the new process of the embodiments herein, less than 2% of the total shaped abrasive particles in the batch demonstrate shape variability from the intended shape. For example, for a batch of shaped abrasive particles formed from a sheet and intended to have a triangular two-dimensional shape, less than 2% of the total shaped abrasive particles of the batch have a non-triangular shape. Moreover, most if not all shaped abrasive particles demonstrating shape variability are formed at the edges of the sheet.

Item 1. A method of forming a shaped abrasive particle comprising:

forming a mixture comprising a ceramic material into a sheet;
sectioning at least a portion of the sheet using a mechanical object and forming at least one shaped abrasive particle from the sheet, wherein sectioning includes controlling at least one process parameter selected from the group consisting of an extrusion height, a sheet moisture content, a sheet solids loading, an orientation of the sheet during sectioning, a pressure differential during sectioning, a blade spacing variation, a blade edge thickness, a ratio of blade edge thickness to blade spacing variation, and a combination thereof.

Item 2. The method of item 1, wherein forming comprises extruding the sheet onto a belt, wherein the sheet contacts a surface of the belt after being extruded through a die opening, wherein the belt is translated while extruding, further comprising controlling an extrusion height defining a distance between the belt and a bottom surface of the die, wherein the extrusion height is greater than zero, wherein the bottom surface of the die is spaced apart from the belt, wherein the extrusion height is substantially the same as the height of the sheet or wherein the extrusion height is at least about 0.5(h), wherein “h” represents the height of the sheet or wherein the extrusion height is not greater than about 3(h).

Item 3. The method of item 1, wherein sectioning comprises completely separating a first portion of the sheet from a second portion of the sheet.

Item 4. The method of item 1, wherein sectioning comprises creating a channel partially separating a first portion of the sheet from a second portion of the sheet, the channel having a height less than a height of the first portion and second portion.

Item 5. The method of item 1, wherein sectioning is conducted on at least a portion of the sheet having a moisture content of at least 10% (Cm0), wherein “Cm0” represents the moisture content of the sheet during forming or at least about 30% (Cm0) or at least about 50% (Cm0) or at least about 75% (Cm0) or at least about 85% (Cm0) or at least about 90% (Cm0) or at least about 95% (Cm0) or wherein sectioning is conducted on at least a portion of the sheet having a moisture content that is substantially the same as the moisture content of the mixture during forming.

Item 6. The method of item 1, wherein sectioning includes applying a pressure differential to the sheet during sectioning, wherein sectioning includes applying a pressure differential via a vacuum table during sectioning, wherein sectioning includes applying a pressure differential to the sheet and limiting movement of the sheet in at least one direction during sectioning.

Item 7. The method of item 1, wherein sectioning comprises translating a plurality of blades through at least a portion of the sheet, wherein the plurality of blades are arranged in a gang configuration, wherein the plurality of blades are separated by blade spacers, wherein the blade spacers define a blade spacer variation of not greater than about 0.01 or not greater than about 0.009 or not greater than about 0.005.

Item 8. The method of item 1, wherein sectioning comprises translating a plurality of blades through at least a portion of the sheet, wherein each blade of the plurality of blades has a blade edge thickness of at least 0.001 mm thick or at least about 0.01 mm thick or at least about 0.02 mm thick or at least about 0.05 mm thick or at least about 0.1 mm thick, and not greater than about 3 mm thick.

Item 9. The method of item 1, wherein sectioning comprises translating a plurality of blades through at least a portion of the sheet, wherein at least one blade of the plurality of blades has a dulled tip, wherein at least one blade of the plurality of blades has a rounded edge, wherein at least one blade of the plurality of blades has a squared edge.

Item 10. The method of item 1, wherein sectioning comprises translating a plurality of blades through at least a portion of the sheet, wherein each blade of the plurality of blades has a blade edge thickness (BET) and wherein each of the blades of the plurality of blades are separated from each other by blade spacers defining a blade spacing variation (BSV), wherein BET>BSV, wherein BET is at least one order of magnitude greater than BSV, wherein sectioning includes using a ratio (BET:BSV) of blade edge thickness to blade spacing variation of at least about 2:1 or at least about 3:1 or at least about 4:1 or at least about 5:1 or at least about 6:1 or at least about 7:1 or at least about 8:1 or at least about 9:1 or at least about 10:1.

Item 11. The method of item 1, wherein the at least one shaped abrasive particle comprises a two-dimensional shape as viewed in a plane defined by a length and a width of the shaped abrasive particle selected from the group consisting of polygons, ellipsoids, numerals, Greek alphabet characters, Latin alphabet characters, Russian alphabet characters, complex shapes having a combination of polygonal shapes, and a combination thereof.

### Example 1

A mixture in the form of a gel is obtained having approximately 52% solids loading of boehmite commercially available as Catapal B from Sasol Corp. combined with 48 wt % water containing a minority content of nitric acid and organic additives. The gel has a viscosity of approximately 8×10⁴ Pa s and a storage modulus of 5×10⁵ Pa, wherein viscosity is calculated by dividing the storage modulus value by 6.28 s⁻¹.

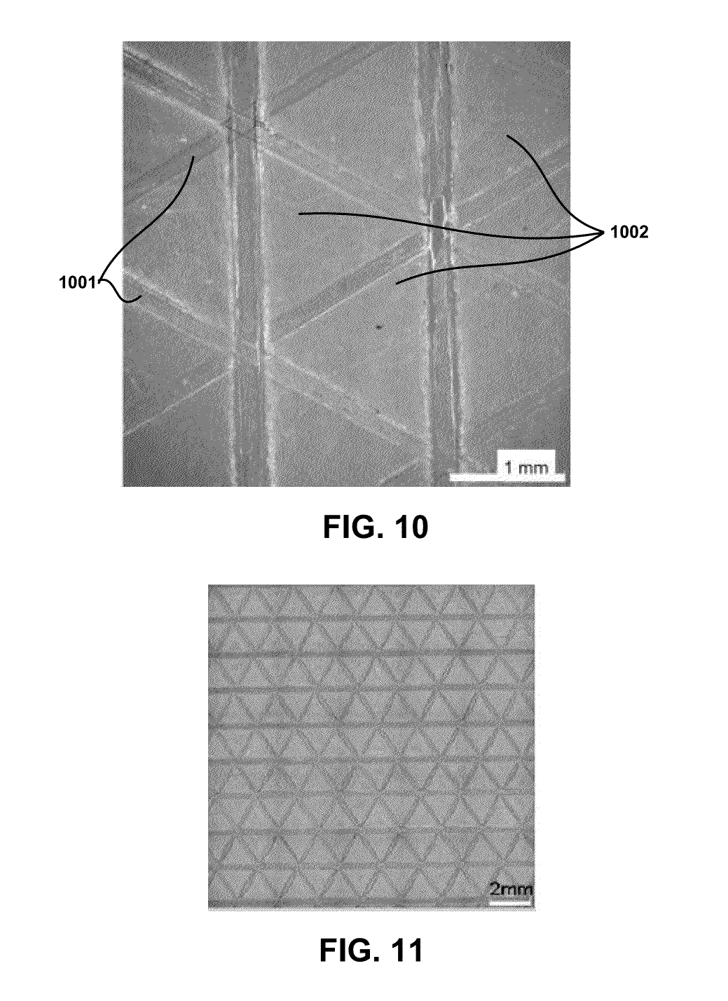

The gel is extruded from a die at approximately 80 psi (552 kPa) onto a translating belt having a film of polyester. The gel travels under a knife edge of the die to form a sheet having a height of approximately 1 mm. The extrusion height (i.e., distance between the belt and lower surface of the die) is approximately 1 mm. Within 10 minutes of extruding, the sheet is sectioned using a blade at ambient atmospheric conditions, in air, and at a temperature of approximately 72° F. to form precursor shaped abrasive particles. The sectioning operation is conducted on the sheet disposed on a vacuum table. The sheet has substantially the same moisture content as the gel at the time of extrusion. Referring to FIG. 10, the sectioning operation included partial sectioning of the sheet to form channels 1001 between the precursor shaped abrasive particles 1002. The precursor shaped abrasive particles are later separated from each other by further processing. The precursor shaped abrasive particles are dried for approximately 1-16 hours and fired at a temperature of approximately 1200° C.-1600° C. for 15 minutes to 1 hour in air. FIG. 11 includes a top down images of the precursor shaped abrasive particles formed in the sheet. FIG. 12 includes a top down image of shaped abrasive particles formed according to Example 1.

The blade mechanism was a multifunction cutter, including 100 blades connected to each other in a ganged configuration. The blade mechanism had a blade spacing of 1.8 mm with a blade spacing variation of 0.0008. The blade mechanism included 100 blades, each with a blade thickness of 0.0.3 mm and having a double bevel dull blade edge shape.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

What is claimed is:

1. A method of forming a shaped abrasive particle comprising:
forming a mixture comprising a ceramic material into a sheet;
sectioning at least a portion of the sheet using a mechanical object and forming at least one shaped abrasive particle from the sheet, wherein sectioning includes controlling at least one process parameter selected from the group consisting of an extrusion height, a sheet moisture content, a sheet solids loading, an orientation of the sheet during sectioning, a pressure differential during sectioning, a blade spacing variation, a blade edge thickness, a ratio of blade edge thickness to blade spacing variation, and a combination thereof.

2. The method of claim 1, wherein forming comprises extruding the sheet onto a belt, wherein the sheet contacts a surface of the belt after being extruded through a die opening, wherein the belt is translated while extruding, further comprising controlling an extrusion height defining a distance between the belt and a bottom surface of the die, wherein the extrusion height is greater than zero, wherein the bottom surface of the die is spaced apart from the belt, wherein the extrusion height is substantially the same as the height of the sheet or wherein the extrusion height is at least about 0.5(h), wherein “h” represents the height of the sheet or wherein the extrusion height is not greater than about 3(h).

3. The method of claim 1, wherein sectioning comprises completely separating a first portion of the sheet from a second portion of the sheet.

4. The method of claim 1, wherein sectioning comprises creating a channel partially separating a first portion of the sheet from a second portion of the sheet, the channel having a height less than a height of the first portion and second portion.

5. The method of claim 1, wherein sectioning is conducted on at least a portion of the sheet having a moisture content of at least 10% (Cm0), wherein “Cm0” represents the moisture content of the sheet during forming or at least about 30% (Cm0) or at least about 50% (Cm0) or at least about 75% (Cm0) or at least about 85% (Cm0) or at least about 90% (Cm0) or at least about 95% (Cm0) or wherein sectioning is conducted on at least a portion of the sheet having a moisture content that is substantially the same as the moisture content of the mixture during forming.

6. The method of claim 1, wherein sectioning includes applying a pressure differential to the sheet during sectioning, wherein sectioning includes applying a pressure differential via a vacuum table during sectioning, wherein sectioning includes applying a pressure differential to the sheet and limiting movement of the sheet in at least one direction during sectioning.

7. The method of claim 1, wherein sectioning comprises translating a plurality of blades through at least a portion of the sheet, wherein the plurality of blades are arranged in a gang configuration, wherein the plurality of blades are separated by blade spacers, wherein the blade spacers define a blade spacer variation of not greater than about 0.01 or not greater than about 0.009 or not greater than about 0.005.

8. The method of claim 1, wherein sectioning comprises translating a plurality of blades through at least a portion of the sheet, wherein each blade of the plurality of blades has a blade edge thickness of at least 0.001 mm thick or at least about 0.01 mm thick or at least about 0.02 mm thick or at least about 0.05 mm thick or at least about 0.1 mm thick, and not greater than about 3 mm thick.

9. The method of claim 1, wherein sectioning comprises translating a plurality of blades through at least a portion of the sheet, wherein at least one blade of the plurality of blades has a dulled tip, wherein at least one blade of the plurality of blades has a rounded edge, wherein at least one blade of the plurality of blades has a squared edge.

10. The method of claim 1, wherein sectioning comprises translating a plurality of blades through at least a portion of the sheet, wherein each blade of the plurality of blades has a blade edge thickness (BET) and wherein each of the blades of the plurality of blades are separated from each other by blade spacers defining a blade spacing variation (BSV), wherein BET>BSV, wherein BET is at least one order of magnitude greater than BSV, wherein sectioning includes using a ratio (BET:BSV) of blade edge thickness to blade spacing variation of at least about 2:1 or at least about 3:1 or at least about 4:1 or at least about 5:1 or at least about 6:1 or at least about 7:1 or at least about 8:1 or at least about 9:1 or at least about 10:1.

11. The method of claim 1, wherein the at least one shaped abrasive particle comprises a two-dimensional shape as viewed in a plane defined by a length and a width of the shaped abrasive particle selected from the group consisting of polygons, ellipsoids, numerals, Greek alphabet characters, Latin alphabet characters, Russian alphabet characters, complex shapes having a combination of polygonal shapes, and a combination thereof.
